(19) United States
(12) Patent Application Publication
(10) Pub. No.: US 2012/0316698 A1
(43) Pub. Date: Dec. 13, 2012

(54) Electrical power distribution and control system and method for remotely controlling power delivery through IP addressable electrical power supply equipment and scanning a network for power control devices

(76) Inventor: REGINALD DANIEL, Mitchellville, MD (US)

(21) Appl. No.: 13/490,149

(22) Filed: Jun. 6, 2012

Related U.S. Application Data
(60) Provisional application No. 61/505,247, filed on Jul. 7, 2011.
(60) Provisional application No. 61/493,931, filed on Jun. 6, 2011.

(51) Int. Cl. G06F 1/26

(52) U.S. Cl. 700/297

(57) ABSTRACT

A power distribution and control system has a wall mounted controller or a transportable controller (e.g., a Smart Phone or wireless Tablet) configured to resemble a solid-state household thermostat having a touchscreen display. The user interface controller provides control options to the user who can selectively enable selected circuit breakers or power strips on a schedule selected by the user. The controller is programmed to control a plurality of identified User Devices such as televisions or other solid-state or computer controlled instruments or appliances, which typically consume power even when in “standby” mode and not in use. The User Devices will be selectively connected to the mains supply only when selectively enabled by Controller inputs, thereby saving valuable energy because the User Devices will not consume any power when not enabled.

### PRIORITY CLAIMS AND CROSS-REFERENCE TO RELATED APPLICATIONS

This application claims priority to and is related to commonly owned and co-pending: (1) U.S. provisional patent application No. 61/493,931 filed Jun. 6, 2011, and (2) U.S. provisional patent application No. 61/505,247, filed Jul. 7, 2011, the entire disclosures of which are incorporated herein by reference.

### BACKGROUND OF THE INVENTION

1. Field of the Invention

The present invention relates to systems and methods for controlling electric power supplied to solid state devices which typically consume power when not in use and in a “standby” mode.

2. Discussion of the Prior Art

Energy and specifically electrical energy is a commodity that is becoming more and more scarce by the day and yet many user and consumers allow electronic and electrical devices to consume this valuable resource while not in use.

Many solid state devices which consume power, even when not in use (e.g., when in a “standby” mode) contain transformers which remain perpetually energized. Many appliances have microcontrollers and related devices which power small light emitting diodes (“LEDs”) and other circuits continuously. In fact, in contemporary households and workplaces, many devices are never turned off. The devices are typically programmed to sense periods of non-use and transition into a standby or sleep mode in order to lessen the time it takes for a given device, when actuated, to become operational. All of these devices, taken together, waste massive amounts of valuable energy.

Electrical power distribution systems are well known in the art. User-controllable systems often include Heating, Ventilation and Air Conditioning (“HVAC”) systems which are typically controlled via a wall-mounted thermostat which may include a solid state controller with timers or heating and cooling mode program selection controls. Solid state HVAC controllers typically are not configured to control anything else.

Internet Protocol (“IP”) addressable Circuit Breaker Panels have been incorporated into bespoke Audio-Video system controls for home theaters and the like and the Lyntec™ brand Internet Protocol (“IP”) addressable Circuit Breaker Panels have been popular among installers of Audio-Video systems. There are also several makers for Internet Protocol (“IP”) addressable power strips, but these devices have disparate and incompatible control interfaces.

What is needed is a comprehensive and simple system and method for controlling scheduled operation of user-selected electrical devices which consume power.

### SUMMARY OF THE INVENTION

Accordingly, it is an object of the present invention to overcome the above mentioned difficulties by providing a power distribution and control system with a wall mounted controller or a transportable controller (e.g., an Iphone™ or Ipad™) configured in a user-friendly way to resemble a solid-state household thermostat having a touchscreen display.

The controller provides control options to the user who can selectively enable selected circuit breakers or power strips on a schedule selected by the user. The controller is programmed to control a plurality of identified User Devices such as televisions or other solid-state or computer controlled instruments or appliances, which typically consume power even when in “standby” mode and not in use. The User Devices will be selectively connected to the mains supply only when selectively enabled by Controller inputs, thereby saving valuable energy because the User Devices will not consume any power when not enabled.

The system remotely controls electrical power supply and selectively distributes power to a user-selected plurality of power consuming devices or appliances which typically use power when in an unused or “standby” state, and includes a first user interface and controller with a display and user input programmed to indicate a plurality of user-selected solid-state devices or appliances and generate an Internet Protocol (“IP”) user instruction signal for transmission in response to selected user inputs identifying desired energy use “on-off” states for each of said selected solid-state devices or appliances. The system also has a panel for distributing electric power to a plurality of outlets or zone boxes configured for use with said selected solid state devices or appliances; the panel including a housing configured to allow at least one main input therein, wherein the main input receives electric power from an outside electrical supply; and the panel further including a plurality of controllable connections secured to the housing; wherein each connection of the plurality of connections is configured to selectively pass electric power from the main input to the plurality of outlets or zone boxes. The system's panel further includes an IP addressable remote circuit power controller configured to receive the transmitted user instruction signal and a terminal assembly connected to said remote circuit power controller and having a control state terminal for each of the controllable connections. Each of the remote circuit power controller's terminals is configured to enable or disable power transmission from the main input to a corresponding controllable connection which selectively passes electric power from the main input to one or more selected solid-state devices or appliances, so that at least one selected solid-state device or appliance which typically uses power when in an unused or “standby” state is controlled to use no power in response to said selected user inputs' desired energy use “on-off” states for said selected solid-state device or appliance.

The system of the present invention can include nearly any IP addressable Power strip or the IP addressable electrical panel of circuit breakers and determines which electrical devices get to use electricity and when. This is done by switching off either the IP addressable individual circuit breakers controlling the devices or the IP addressable plug controlling the devices. The system is programmable to operate on a user-defined or predetermined schedule or the schedule can be overridden and can be controlled manually. The user interface or controller includes a touch panel, an IP addressable circuit breaker panel, and optionally an IP addressable power strip, all connected together via an Ethernet switch or router. The user interface or controller's resident programming allows user adjustable control or the IP addressable Breaker Panel and the IP addressable power strip and any other devices or component which are responsive to or plugged into the Ethernet switch (e.g., through cat 5 cable or other network cable) and execute device state (e.g., “on or off”) instructions according to the programmed schedule or input from the user.

The system of the present invention can reduce electrical consumption by creating a single point of intersection and control to achieve savings of between 10 and 25 percent of total electrical consumption.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIGS. 1A and 1B illustrate a first user interface and controller, in accordance with the present invention.

FIG. 2 illustrates a system for remotely controlling distribution of power to selected user devices, in accordance with the present invention.

FIGS. 3A-3D illustrate an IP addressable Power panel configured for remote control of user device power, in accordance with the present invention.

FIGS. 4A and 4B illustrate an IP addressable Power Strip for use in the system of the present invention.

FIGS. 5A-5C illustrate the programmable method for identifying and controlling power delivery to selected user devices, in accordance with the present invention.

FIGS. 6A-6B illustrate the programmable method for identifying and controlling power delivery to selected user devices, in accordance with the present invention.

FIG. 7 illustrates the communication method for identifying and controlling power delivery to selected user devices, in accordance with the present invention.

FIG. 8 illustrates the communication network used for identifying and controlling power delivery to selected user devices, in accordance with the present invention.

### DETAILED DESCRIPTION OF THE PREFERRED EMBODIMENTS

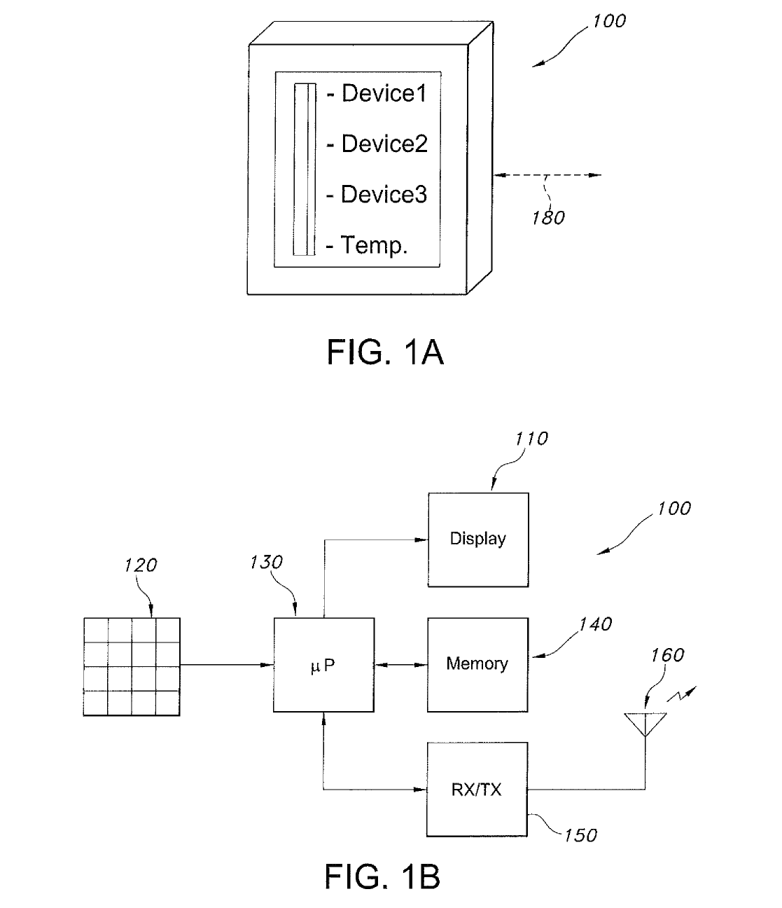

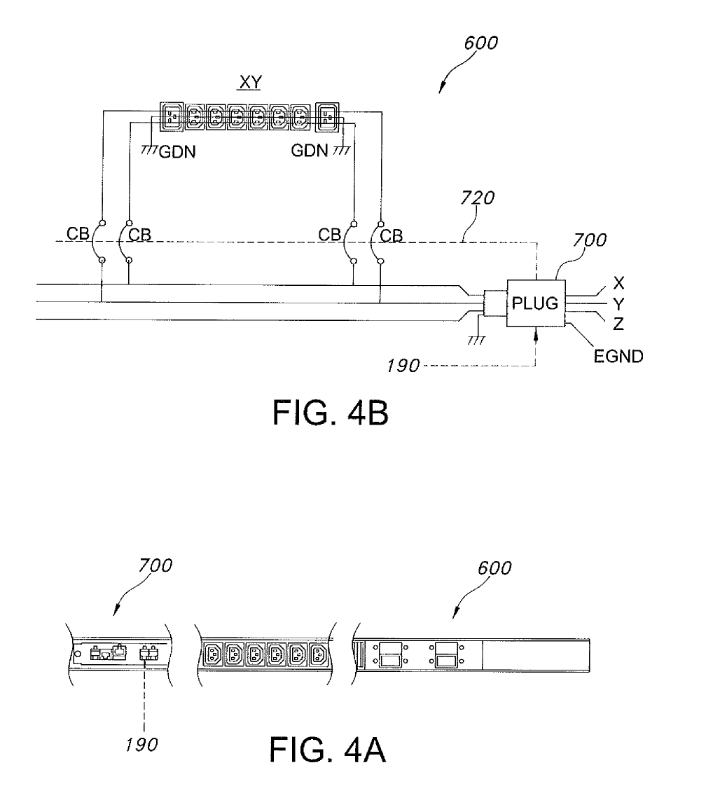

Turning now to FIGS. 1-8, the system 50 of the present invention has a first user interface and controller 100 which provides control options to the user who can selectively enable selected circuit breakers or power strips on a schedule selected by the user. First user interface and controller 100 preferably includes a wall mountable transportable housing enclosing a microprocessor 130 connected to and responsive to a keyboard or touchscreen input sensor array 120 and a Display 110. First user interface controller's microprocessor 130 is configured with a program storage memory 140 and a digital data telemetry transceiver circuit 150 which is preferably connected with an antenna 160. First user interface and controller 100 is programmed to control a plurality of identified User Devices (e.g., 510, 520, and 530) such as televisions or other solid-state or computer controlled instruments or appliances, which typically consume power even when in “standby” mode and not in use. The User Devices User Devices 510, 520, 530 will be selectively connected to the electrical energy source or Mains Supply only when selectively enabled by Controller inputs, thereby saving valuable energy because the User Devices will not consume any power when not enabled.

The system 50 remotely controls electrical power supply and selectively distributes power to a user-selected plurality of the power consuming devices or appliances User Devices (e.g., 510, 520, 530) which typically use power when in an unused or “standby” state, and includes a first user interface and controller 100 with a display 110 and user input 120 programmed to indicate a plurality of user-selected solid-state devices or appliances (e.g., 510, 520, 530) and generate an Internet Protocol (“IP”) user instruction signal 180 for transmission in response to selected user inputs identifying desired energy use “on-off” states for each of said selected solid-state devices or appliances. The system also has a panel 300 for distributing electric power to a plurality of outlets or zone boxes (e.g., 600) configured for use with said selected solid state devices or appliances; the panel including a housing configured to allow at least one main input therein, wherein the main input receives electric power from an outside electrical supply; and the panel further including a plurality of controllable connections secured to the housing; wherein each connection of the plurality of connections is configured to selectively pass electric power from the main input to the plurality of outlets or zone boxes. The system's panel 300 further includes an IP addressable remote circuit power controller 400 configured to receive the transmitted user instruction signal (e.g., 180 or 190) and a terminal assembly connected 420 to said remote circuit power controller 400 and having a control state terminal for each of the controllable connections. Each of the remote circuit power controller's terminals is configured to enable or disable power transmission from the main input to a corresponding controllable connection which selectively passes electric power from the main input to one or more selected solid-state devices or appliances or User Devices (e.g., 510, 520, 530), so that at least one selected solid-state device or appliance (e.g., 510 which typically uses power when in an unused or “standby” state is controlled to use no power in response to said selected user inputs' desired energy use “on-off” states for said selected solid-state device or appliance.

The system of the present invention can include nearly any IP addressable Power strip (e.g., 600) or the IP addressable electrical panel of circuit breakers (e.g., 300) and determines which electrical devices get to use electricity and when. This is done by switching off either the IP addressable individual circuit breakers controlling the devices or the IP addressable plug controlling the devices. The system 50 is programmable to operate on a user-defined or predetermined schedule or the schedule can be overridden and can be controlled manually. The system has user interface 100 and optionally includes a touch panel, an IP addressable circuit breaker panel (e.g., 300), and optionally an IP addressable power strip, all connected together via an Ethernet switch or router. The user interface or controller's resident programming is stored in memory 140 and allows user adjustable control or the IP addressable Breaker Panel 300 and the IP addressable power strip 600 and any other devices or component which are responsive to or plugged into the Ethernet switch or router 200 (e.g., through cat 5 cable or other network cable) and execute device state (e.g., “on or off”) instructions according to the programmed schedule or input from the user.

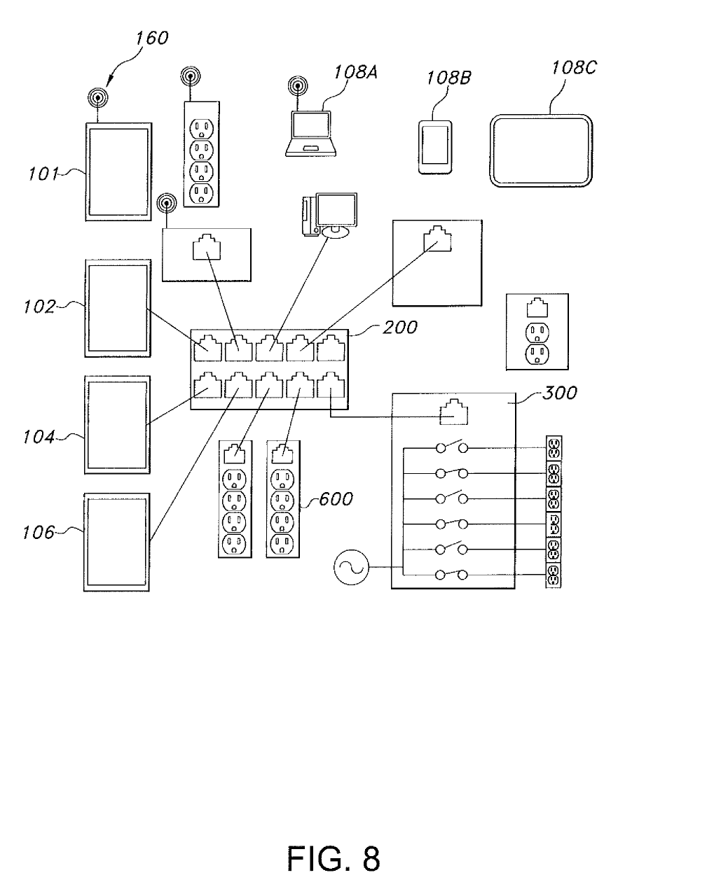

System 50 and the method of the present invention can reduce electrical consumption by creating a single point of intersection and control to achieve savings of between 10 and 25 percent of total electrical consumption. IP addressable power control technologies are employed to configure and program a single user interface (e.g., user interface 100) similar to a Thermostat providing seamless control over when any user-selected device (e.g., 510, 520 or 530) is allowed to use power. Typical homes and businesses have many devices (e.g., 510, 520 or 530) plugged into outlets. Applicant has learned that that these devices, even when in not used and in a “standby” mode often comprise from 10 to 25 percent of a user's total electrical consumption. The Applicant investigated how IP addressable Circuit Breaker Panels and IP addressable power strips could be adapted and configured to control devices like these through a single simple interface. That is when applicant sought to configure and program a single device user interface 100 that can run a schedule and determine which electrical devices get to consume power. User interface 100 is programmed with a software program and provides a control product which the user will adopt easily because it resembles a Thermostat panel and displays controlled devices (e.g., 510, 520 or 530) and scheduling options for power to be supplied to those devices. The user interface 100 generates a user instruction signal 180 which is transmitted to I/P addressable controller 400 in an electrical (e.g., Square D brand) panel 300 having circuit breakers (e.g., a prototype of system 50 includes a panel by Lyntec™), and other devices such as IP addressable power strips 600 or any other device that is addressable on an included network and selected to be a part of system 50 (see FIG. 8).

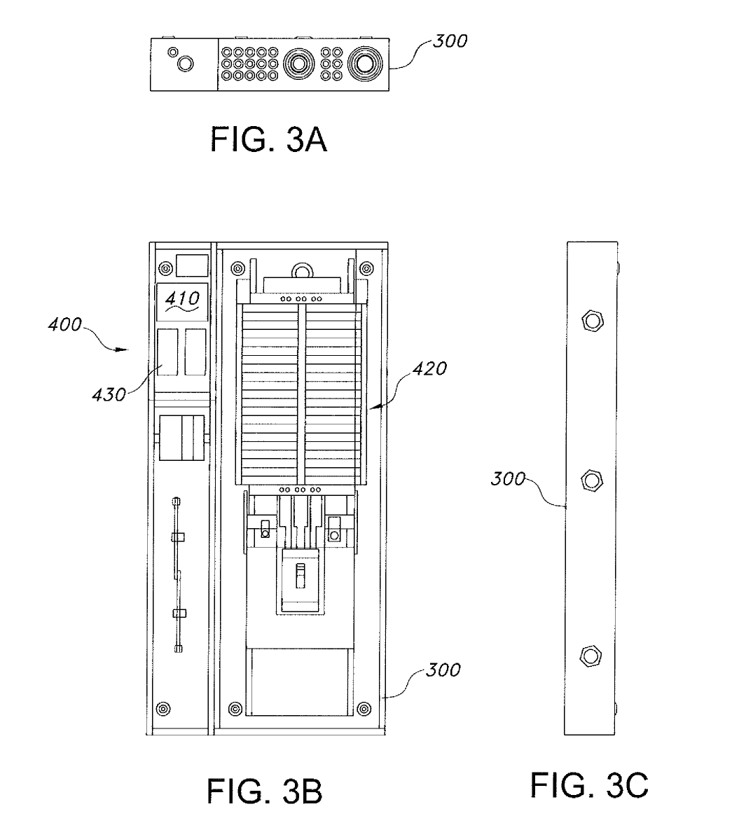

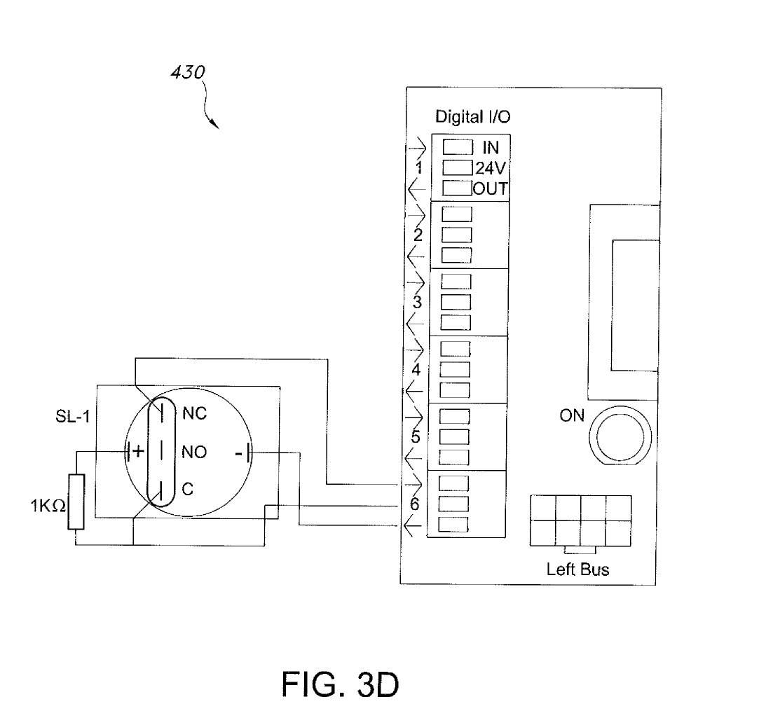

FIGS. 3A-3D illustrate an exemplary embodiment of an IP addressable Breaker Panel 300 which is housed in a conventional electrical panel enclosure and configured for use in system 50 and having an IP addressable controller 400 with a transceiver 410 configured to transmit device state data and receive instruction signals 180 and 190, which are then used to generate control signals for controlling circuit breakers 420. Optional Digital Input-Output circuits 430 in controller 400 are configured to energize terminals for controlling relays and the like as illustrated in FIG. 3D.

The user interface 100 has display/controller program interface (e.g., GUI) which is programmed to display (on display 110) selectable control inputs or software defined control buttons labeled: “run program”, “sleep”, “return”, and “away” which define schedule selections for selected electrical wiring circuits controlled by the software, and those selections are used to encode or modulate the user instruction signals 180 and 190 with device control data (for controlling devices e.g., 510, 520 or 530). Designated circuit breakers 420 corresponding to designated circuits or outlets (e.g., powering selected, connected devices 510, 520 or 530) are switched on or off according to the user-defined instruction signals 180 and 190.

User interface 100 displays a controlled device list which includes: Breakers (e.g., 420) connected to the panel 300, Networked power strips (e.g., 600, WIFI or physically connected) Sensors or Action devices such as motion detectors. In accordance with the present invention, Controlled devices (e.g., 510, 520 or 530) are placed into 4 major categories:

(1) Always ON and not subject to emergency interruption—RED
(2) Always on subject to emergency interruption—ORANGE
(3) Run according to schedule subject to manual interruption within group—BLUE
(4) Default state is off unless manually interrupted by actions such as Motion sensor, command from touch panel or from computer or other device. By default will be turned off as a part of Blue schedule—GREEN
The User's control panel 100 has a “Home” Screen with 7 buttons enabling a user to select:

### (1) Run Program

### (2) Sleep

### (3) Awake

### (4) Away

### (5) Return

### (6) Bypass—ALL ON

### (7) Control Zone

The “Control Zone” screen (e.g., on display 110) has a control input 120 or software “button” for every zone (which selects the zone and takes the user to the selected zone's page) as well as a RETURN button and a NEXT PAGE button. Once a Zone is selected, the Zone Screen appears and preferably displays the following user-selectable buttons:

Group Name (which ties to a logical set of devices possibly on the same breaker or not) with
ON and OFF buttons immediately near (Optionally) a
NEXT PAGE button and

### BACK BUTTON and

HOME BUTTON on bottom.

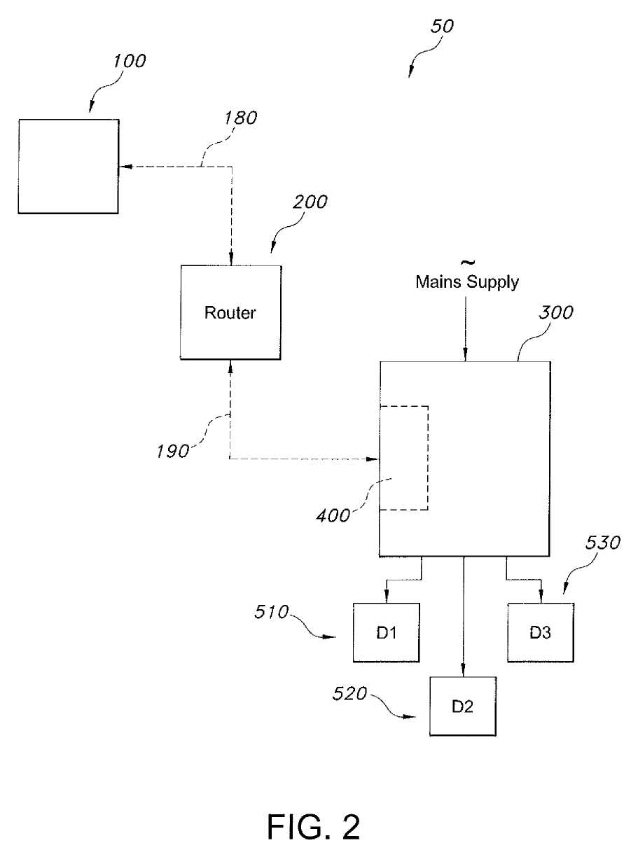

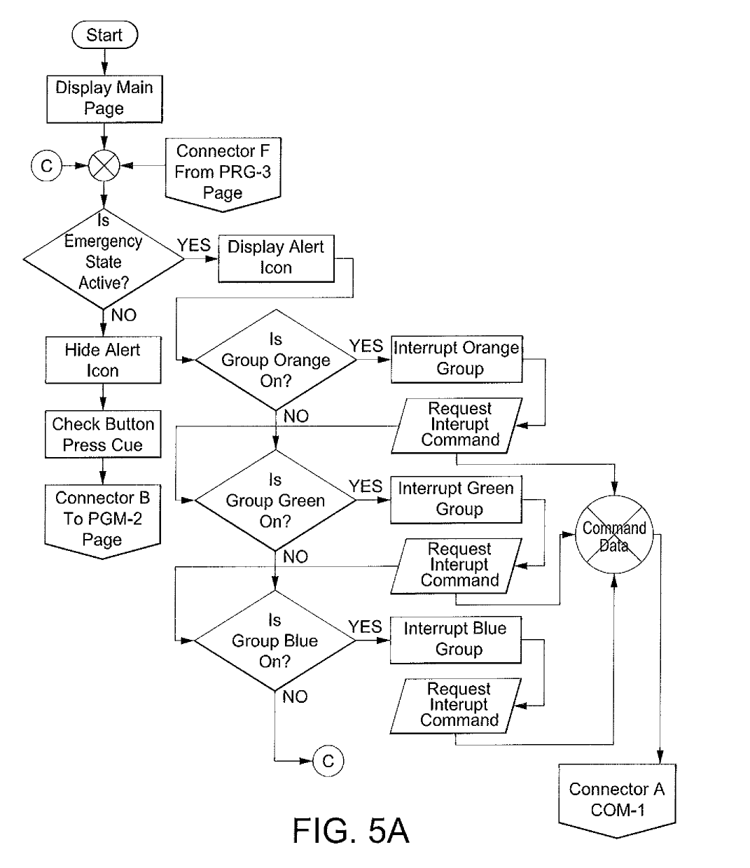

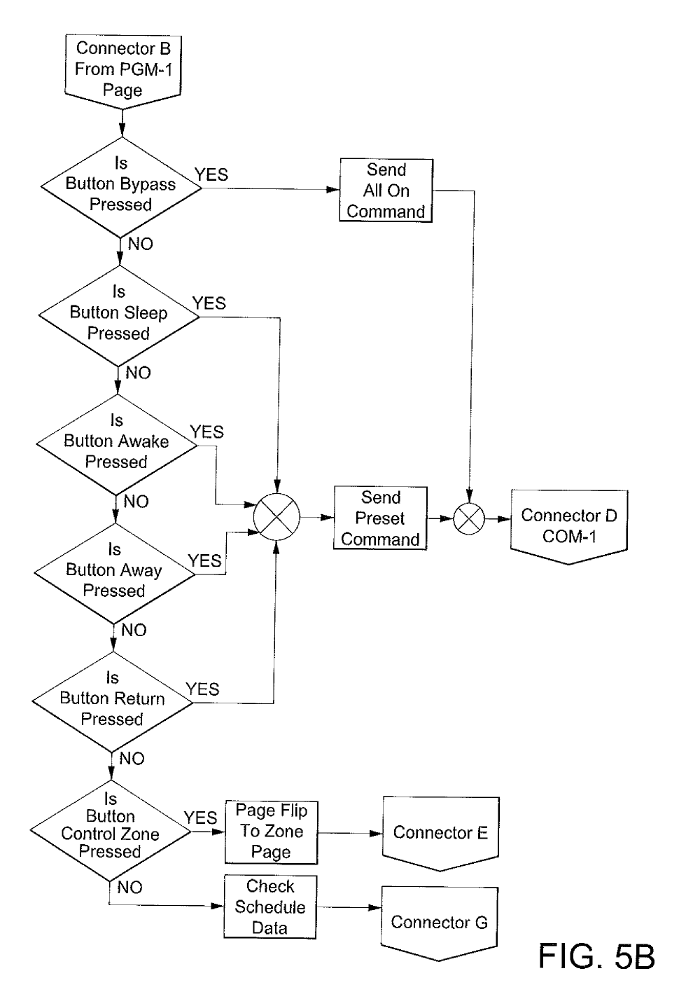

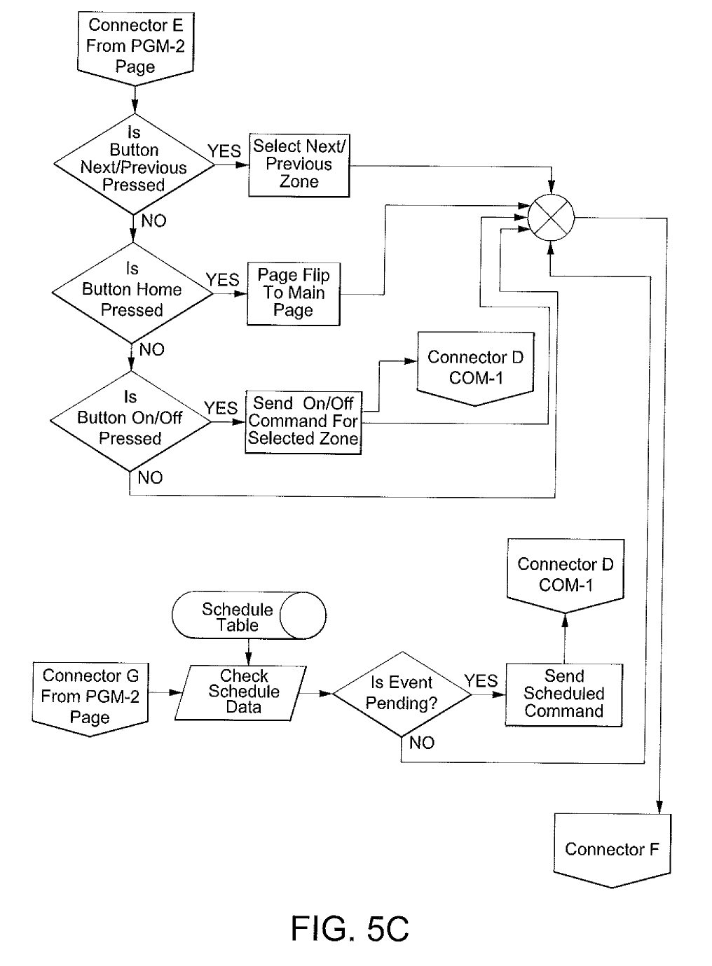

The applicant investigated how IP addressable Circuit Breaker Panels (e.g., 300) and IP addressable power strips (e.g., 600) could be adapted and configured to control plug-in devices (e.g., 510, 520 or 530) through a single simple interface. The control panel 100 and system 50 of the present invention provide single user-control device that can run a schedule and determine which electrical devices get to consume power. The system and method of the present invention include touch panel 100 (see FIGS. 1A, 1B and 2) configured to execute the control program illustrated in FIGS. 5A-7 and provides a similar look and feel to most users except, instead of controlling Heating and Air Conditioning, the panel of the present invention controls power to selected devices (e.g., 510, 520 or 530).

As noted above, energy is an increasingly valuable commodity and yet many solid-state devices consume this valuable resource while not needed or in use. Many electrical devices contain transformers or even small lights or LEDs. In fact, many devices (e.g., 510, 520 or 530) are never turned off. They just go into a “standby” or “sleep” mode in order to lessen the time it takes for it to become operational, thus wasting valuable energy. The ELECTRISTAT™ system 50 of the present invention is one solution to these problems. System 50 uses an IP addressable Power strip 600 or a device such as the Lyntec™ brand IP addressable electrical panel 400 of circuit breakers 420 and determines which electrical devices (e.g., 510, 520 or 530) get to use electricity and when. This is done by switching off either the IP addressable individual circuit breakers 420 controlling the devices or the IP addressable plug 600 controlling delivery of electrical power to the devices.

System 50 is designed to operate according to a predetermined or preprogrammed schedule (as illustrated in FIGS. 5A-7) or the schedule can be overridden and can be controlled manually. The ELECTRISTAT user interface 100 through its resident programming is able to control the IP addressable Breaker Panel 300 and the IP addressable power strip 600 and any other component responsive to a network (e.g., plugged into a Router or Ethernet switch 200 through cat 5 cable or other network cable) and execute “on or off” instructions according to instruction signals 180 and 190 in response to the programmed schedule or input from the user. System 50 is therefore configured to reduce needless electrical consumption through combining current commercial off the shelf technology and creating a single point of intersection and control, and, in use, system 50 has been observed to achieve savings of between 10 and 25 percent of total electrical consumption for a household or commercial facility. The system 50 uses any household or office wired or wireless digital data communications network to provide a control system to determine which devices (e.g., 510, 520 or 530) get to consume power and which do not. The user conceived schedule or manual input to user interface 100 will remotely control power distribution to each device. The appliances or electrical devices (e.g., 510, 520 or 530) can include video displays, televisions, computers, photocopiers, coffee makers, fax machines or Video Disc-DVD players which, like many solid-state devices, have a “standby” or “sleep” mode when not in use and yet which remain energized to consume valuable electricity.

### Software Portion of the Present Invention:

FIGS. 5A-7 further illustrate the software controlled process portion of system 50 and the method of the present invention. As noted above, the IP addressable power control components (e.g., 300 and 600) are configured and programmed via a single user interface 100 similar to a Thermostat to provide control over any user-selected device (e.g., 510, 520 or 530). The system of the present invention defines when any appliance or device may use power. Applicant has learned that that electronics and electrical devices plugged into outlets often account for 10 to 25 percent of a user's total electrical consumption. IP addressable Circuit Breaker Panels 300 and IP addressable power strips 600 are configured and programmed to control devices like these through a single simple interface (of the type shown in FIG. 1). The programs illustrated in FIGS. 5A-8 control a schedule and determine which electrical devices get to consume power.

In accordance with the method of the present invention, as illustrated in FIGS. 5A-7, a method for distributing power to and controlling electrical equipment and devices (e.g., 510, 520 or 530) through IP addressable electrical power supply equipment (e.g., 300 or 600) and scanning a wired or wireless network (see FIG. 8) for power control devices, includes the method steps of:

(A) providing a first programmable user interface and controller 100 with a display 110 and user input 120;

(B) programming said first user interface and controller to select, indicate or identify a plurality of user-selected solid-state devices or appliances (e.g., 510, 520 or 530) and generate an Internet Protocol (“IP”) user instruction signal (180, 190) for transmission in response to selected user inputs identifying desired energy use “on-off” states for each of said selected solid-state devices or appliances;

(C) providing a panel 300 or 600 for distributing electric power to a plurality of outlets or zone boxes configured for use with said selected solid state devices or appliances; the panel including a housing configured to allow at least one main input therein, wherein the main input receives electric power from an outside electrical supply; and the panel further including a plurality of controllable connections secured to the housing; wherein each connection of the plurality of connections is configured to selectively pass electric power from the main input to the plurality of outlets or zone boxes; the panel further including an IP addressable remote circuit power controller (e.g., 400) configured to receive the transmitted user instruction signal (190) and a terminal assembly connected to said remote circuit power controller and having a control state terminal for each of said controllable connections; wherein each of said remote circuit power controller's terminals is configured to enable or disable power transmission from the main input to a corresponding controllable connection (e.g., among circuit breakers 420) which selectively passes electric power from the main input to one or more selected solid-state devices or appliances, so that at least one selected solid-state device or appliance (e.g., 510, 520 or 530) which typically uses power when in an unused or “standby” state is controlled to use no power in response to said selected user inputs' desired energy use “on-off” states for said selected solid-state device or appliance;

(D) connecting a first user-selected solid-state devices or appliances (e.g., 510, 520 or 530) to a first panel controllable connection; and

(E) enabling power transmission to said first user-selected solid-state devices in response to said programming of said first user interface and controller 100 to select said first user-selected solid-state device or appliance by generating a first Internet Protocol (“IP”) user instruction signal for transmission in response to selected user inputs identifying a desired energy use “on” states for said first solid-state devices or appliances.

The method may further comprise: (F) programming said first user interface and controller to indicate, for said user-selected solid-state device or appliance, whether said device or appliance is subject to emergency interruption; and (G) programming said first user interface and controller to indicate, for said user-selected solid-state device or appliance, whether said device or appliance is subject to manual interruption; and (H) programming said first user interface and controller to indicate, for said user-selected solid-state device or appliance, whether said device or appliance is subject to operation according to a user-defined schedule.

The method may further comprise: showing, on display 110 color-coded indicia adapted to easily segregate the devices (e.g., 510, 520 or 530) into categories of differing importance or readiness, or (I) programming said first user interface and controller to indicate, for said user-selected solid-state device or appliance, whether said device or appliance is belongs to one of four groups, namely, (i) a RED device or appliance which is always on and not subject to emergency interruption; (ii) an ORANGE device or appliance which is always on and subject to emergency interruption; (iii) a BLUE device or appliance which is enabled or run in response to said user-defined schedule and subject to manual interruption and emergency interruption; or (iv) a GREEN device or appliance which is normally “off” and subject to emergency interruption and manual interruption. The method may further comprise: (J) Transmitting a desired energy use “on-off” states (e.g., in user instruction signals 180 190) for said selected solid-state device or appliance (e.g., 510, 520 or 530) to said panel (e.g., 300 or 600) via a network (e.g., Ethernet) connection, either by a wired connection (e.g., via Cat 5 Cable) or via wireless data telemetry (e.g. WIFI or 802.11 wireless data transmission. Alternatively, user instruction signals can be generated within and transmitted from an alternative user interface configured as Wireless laptop computer 108A, a Smart Phone device 1088 or wireless enabled Tablet device 108C programmed with an “App” or software Application including program instructions (illustrated in FIGS. 5A-7) to transmit said desired user instruction signal 180, 190, with the energy use “on-off” states for each of said selected solid-state devices or appliances (e.g., 510, 520 or 530), as shown in FIG. 8.

The display/controller program interface (e.g., GUI) for any of the user interfaces (e.g., 100, 102, 104, 106, 108A, 108B, 108C) includes control buttons labeled “run program”, “sleep”, “return”, and “away” which define schedule selections for selected electrical wiring circuits controlled by the software. Designated circuit breakers (e.g., 420 or 430) corresponding to designated circuits or outlets are switched on or off according to the user-defined schedule or manual inputs.

As noted above, the controlled device list includes:
Breakers (e.g., 420 or 430) connected to panel 300
Networked power strips (e.g., 600, WIFI or physically connected)
Sensors or Action devices such as Alarm system motion detectors
   Controlled devices are preferably segregated or placed into the 4 major categories:
   (1) Always ON and not subject to emergency interruption—RED
   (2) Always on subject to emergency interruption—ORANGE
   (3) Run according to schedule subject to manual interruption within group—BLUE
   (4) Default state is off unless manually interrupted by actions such as Motion sensor, command from touch panel or from computer or other device. By default will be turned off as a part of Blue schedule—GREEN.
   The User's control panel (e.g., 100, 102, 104, 106, 108A, 108B, 108C) has preferably includes a “Home” Screen with 7 buttons enabling a user to select:

### (1) Run Program

### (2) Sleep

### (3) Awake

### (4) Away

### (5) Return

### (6) Bypass—ALL ON

### (7) Control Zone

The “Control Zone” screen has a button for every zone (which selects the zone and takes you to that page) as well as a RETURN button and a NEXT PAGE button.

Once a Zone is selected, the Zone Screen appears and preferably displays the following user-selectable buttons:

Group Name (which ties to a logical set of devices possibly on the same breaker or not) with
ON and OFF buttons immediately near Possibly a
NEXT PAGE button and

### BACK BUTTON and

HOME BUTTON on bottom.

It is evident that various modifications could be made to the present invention without departing from the basic teachings thereof, and that the descriptive text of these embodiments is not intended to define the scope of the present invention. Therefore, when the text of this patent application discloses particular components and configurations and arrangements of these components, this description is not intended to limit corresponding recitations of these components in the claims to that particular configuration or component.

Also, the various relationships of the design parameters of the embodiments as disclosed in the previous text are characteristic of the apparatus being designed for one application, and yet could be used in a variety of applications. Nevertheless, the design requirements may be rather different for different applications, such as operating in different environments, the need to have different dimensional requirements due to the configuration or characteristics of the structure or other device with which it is to be associated, etc.

Thus, while some of these relationships may be applicable to these somewhat modified designs, it could be that others are not. Therefore, providing this information of these various design parameters is not necessarily to limit the scope of the claims in covering apparatus which may be totally outside of some of those relationships, and the scope of the claims is not intended to be limited to incorporating any or all of these design requirements, without departing from the basic teachings of the present invention.

FIGS. 2, 7 and 8 further illustrate the system 50 and method of the present invention accounting for wireless devices such as power distribution units (e.g., 300, 600) and user interface controllers (e.g., 100, 102, 104, 106, 108A, 108B, 108C) to be added. The software programs illustrated in FIGS. 5A-7 provide the ability to scan a network for power control devices to be added to the system. The Program controls a collection of power control devices via an Ethernet network connection. Devices that can be controlled by the system include, but are not limited to, micro-controller controlled circuit breakers, Ethernet-controlled power strips, Ethernet-controlled power distribution units, or any other IP addressable or Ethernet-controlled power device.

Returning to FIG. 5A, the devices (e.g., 510, 520 or 530) are identified and segregated by the user into the following groups:

Red Group Devices assigned to the Red group are always on and are not subject to emergency interruption.
Orange Group Devices assigned to the Orange group are always on and are subject to emergency interruption.
Green Group Devices assigned to the Green group run according to a schedule and are subject to manual and emergency interruption.
Blue Group Devices assigned to the Blue group are off by default. Devices in this zone are subject to emergency and manual interruption.

The control process illustrated in FIGS. 5A-5C begins by displaying the main control page of the touch panel program on the touch panel interface(s). The program then executes a process loop. The process loop runs continuously.

### Functions of the Process Loop

1. Check for emergency state, and if active, execute alternate branch of process.
2. Hide or display icon(s) on the touch panel interface(s).
3. Check for button presses on touch panel interface(s) and execute branches accordingly.
4. Check the event schedule for pending events and execute event actions if event(s) are pending.

### Emergency State

When the emergency state active branch of the program is run, the groups that are designated as emergency interruption zones are switched off. Orange group, Green group, and Blue group are designated as emergency interruption zones. For each of these zones, circuit table information is requested from memory and the devices associated with the associated zones are switched off. An alert icon is displayed on the touch panel interface(s).

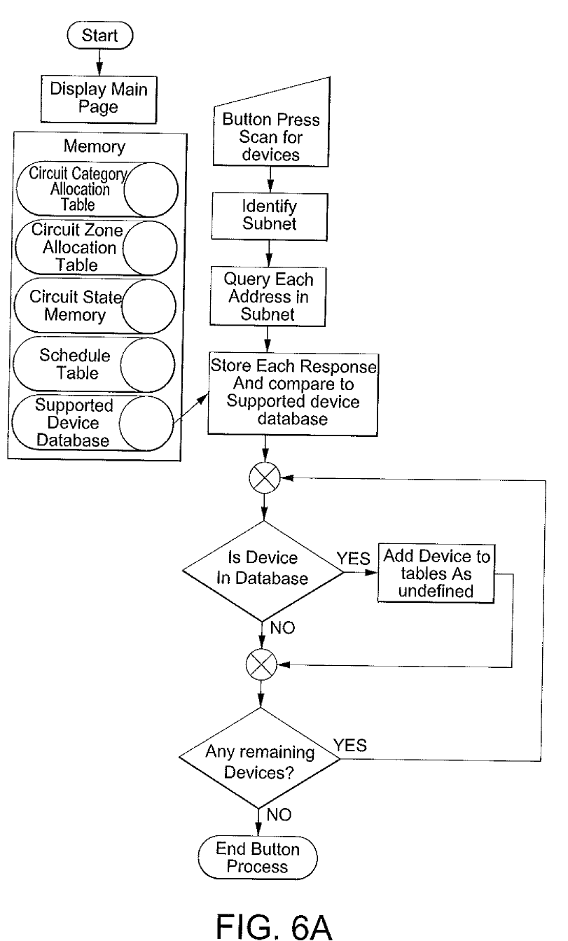

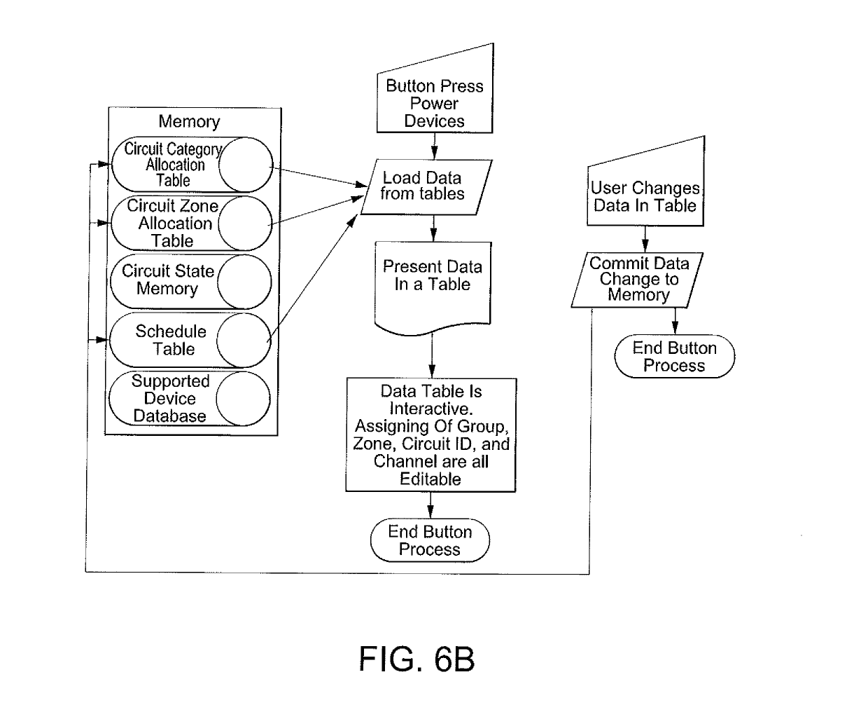

### Button Functions (see FIGS. 6A and 6B):

### Bypass Button:

The Bypass button commands the program to set the power state of all zones in the system to on.

### Sleep Button, Awake Button, Away Button, Return Button:

The Sleep, Awake, Away, and Return buttons command the program to execute a preset that turns on or off groups or zones that have been defined and associated with each preset.

### Control Zone Button:

The control zone button commands the touch panel interface to flip to a page that displays a selected zone and power on/off override buttons. A next button and a previous button are on the bottom of the page, which switch between the different zones. A home button is displayed which commands the touch panel interface to flip to the main control page. Individual zones can be turned on or off with the controls on this page.

### Device Polling:

### Description of Poll Cycle:

1. Load circuit data from memory.
2. Select first or next entry from table of circuits and devices.
3. Send status request command to power control device.
4. Wait for an indeterminate amount of time.
5. Return to step two and continue execution.

Responses from status commands sent to devices being polled are handled as they arrive. If a state of a device does not match the state that the program is expecting the program sends a command to the device to change to the expected state.

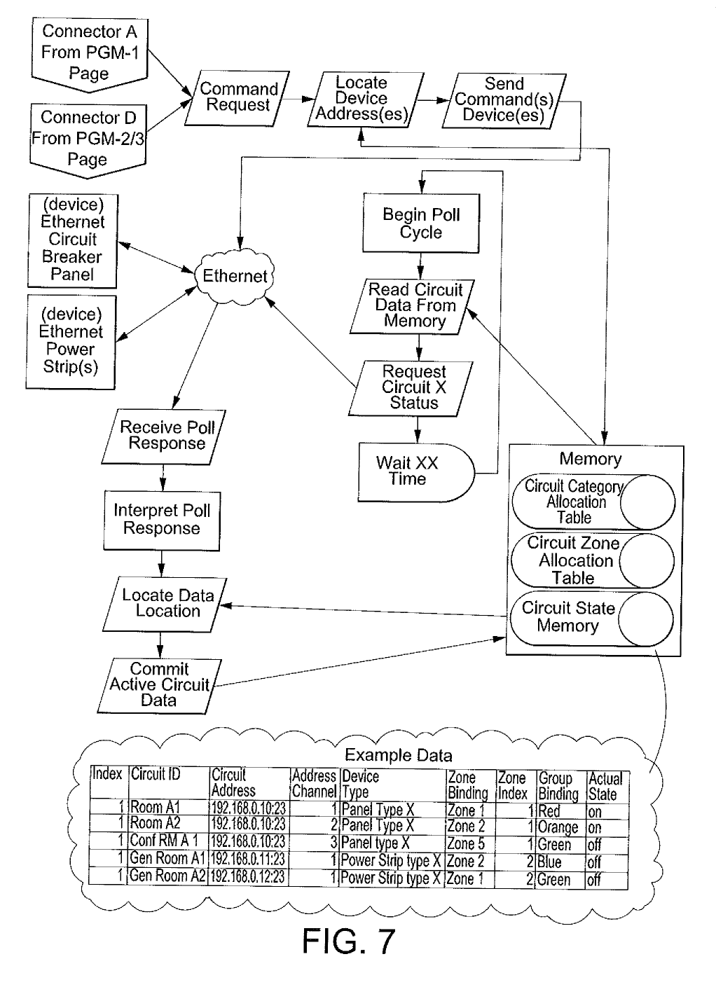

### Setup Program (see FIGS. 6A, 6B and 7):

The setup program is run as a standalone application or an application hosted on an embedded web server. The function of the setup application is to define power control device assignments and to manage the power control scheduler.

The setup program facilitates scanning the network for compatible power control devices. When the “Scan for devices” button is pressed, the network is scanned for compatible power control devices. When compatible devices are found on the network, the devices are added to the memory tables as “Unallocated Devices”.

The list of power control devices is presented as an editable table when the “Power Devices” button is pressed. The data fields of Group, Zone, Circuit ID, and Channel are all editable.

Having described preferred embodiments of a new and improved system 50, apparatus and method, it is believed that other modifications, variations and changes will be suggested to those skilled in the art in view of the teachings set forth herein. It is therefore to be understood that all such variations, modifications and changes are believed to fall within the scope of the present invention as set forth in the following claims.

What is claimed is:

1. A system for remotely controlling electrical power supply and selectively distributing power to power consuming devices or appliances which typically use power when in an unused or “standby” state, comprising:
a first user interface and controller with a display and user input programmed to indicate a plurality of user-selected solid-state devices or appliances and generate an Internet Protocol (“IP”) user instruction signal for transmission in response to selected user inputs identifying desired energy use “on-off” states for each of said selected solid-state devices or appliances;
a panel for distributing electric power to a plurality of outlets or zone boxes configured for use with said selected solid state devices or appliances; the panel including a housing configured to allow at least one main input therein, wherein the main input receives electric power from an outside electrical supply; and the panel further including a plurality of controllable connections secured to the housing; wherein each connection of the plurality of connections is configured to selectively pass electric power from the main input to the plurality of outlets or zone boxes;
the panel further including an IP addressable remote circuit power controller configured to receive the transmitted user instruction signal and a terminal assembly connected to said remote circuit power controller and having a control state terminal for each of said controllable connections;
wherein each of said remote circuit power controller's terminals is configured to enable or disable power transmission from the main input to a corresponding controllable connection which selectively passes electric power from the main input to one or more selected solid-state devices or appliances, so that at least one selected solid-state device or appliance which typically uses power when in an unused or “standby” state is controlled to use no power in response to said selected user inputs' desired energy use “on-off” states for said selected solid-state device or appliance.

2. The system for remotely controlling electrical power supply and selectively distributing power of claim 1, wherein said first user interface and controller is programmed to indicate, for each user-selected solid-state device or appliance, whether said device or appliance is subject to emergency interruption.

3. The system for remotely controlling electrical power supply and selectively distributing power of claim 2, wherein said first user interface and controller is programmed to indicate, for each user-selected solid-state device or appliance, whether said device or appliance is subject to manual interruption.

4. The system for remotely controlling electrical power supply and selectively distributing power of claim 1 wherein said first user interface and controller is programmed to indicate, for each user-selected solid-state device or appliance, whether said device or appliance is subject to operation according to a user-defined schedule.

5. The system for remotely controlling electrical power supply and selectively distributing power of claim 4, wherein said first user interface and controller is programmed to indicate, for each user-selected solid-state device or appliance, whether said device or appliance is belongs to one of four groups, namely,
(a) a device or appliance which is always on and not subject to emergency interruption;
(b) a device or appliance which is always on and subject to emergency interruption;
(c) a device or appliance which is enabled or run in response to said user-defined schedule and subject to manual interruption and emergency interruption; or
(d) a device or appliance which is normally “off” and subject to emergency interruption and manual interruption.

6. The system for remotely controlling electrical power supply and selectively distributing power of claim 5, wherein said first user interface and controller is configured to transmit said desired energy use “on-off” states for each of said selected solid-state devices or appliances to said panel via an Ethernet connection.

7. The system for remotely controlling electrical power supply and selectively distributing power of claim 6, wherein a second user interface and controller is configured to transmit said desired energy use “on-off” states for each of said selected solid-state devices or appliances to said panel via wireless data telemetry.

8. The system for remotely controlling electrical power supply and selectively distributing power of claim 6, wherein said first user interface and controller is configured to transmit said desired energy use “on-off” states for each of said selected solid-state devices or appliances to said panel via wireless data telemetry.

9. The system for remotely controlling electrical power supply and selectively distributing power of claim 8, wherein said first user interface and controller is configured as a Smart Phone device or wireless enabled Tablet device programmed with an Application including program instructions to transmit said desired energy use “on-off” states for each of said selected solid-state devices or appliances to said panel via wireless data telemetry.

10. A method for distributing power to and controlling electrical equipment and devices through IP addressable electrical power supply equipment and wirelessly scanning a network for power control devices, comprising the method steps of:
(A) providing a first programmable user interface and controller with a display and user input;
(B) programming said first user interface and controller to select, indicate or identify a plurality of user-selected solid-state devices or appliances and generate an Internet Protocol (“IP”) user instruction signal for transmission in response to selected user inputs identifying desired energy use “on-off” states for each of said selected solid-state devices or appliances;
(C) providing a panel for distributing electric power to a plurality of outlets or zone boxes configured for use with said selected solid state devices or appliances; the panel including a housing configured to allow at least one main input therein, wherein the main input receives electric power from an outside electrical supply; and the panel further including a plurality of controllable connections secured to the housing; wherein each connection of the plurality of connections is configured to selectively pass electric power from the main input to the plurality of outlets or zone boxes; the panel further including an IP addressable remote circuit power controller configured to receive the transmitted user instruction signal and a terminal assembly connected to said remote circuit power controller and having a control state terminal for each of said controllable connections; wherein each of said remote circuit power controller's terminals is configured to enable or disable power transmission from the main input to a corresponding controllable connection which selectively passes electric power from the main input to one or more selected solid-state devices or appliances, so that at least one selected solid-state device or appliance which typically uses power when in an unused or “standby” state is controlled to use no power in response to said selected user inputs' desired energy use “on-off” states for said selected solid-state device or appliance;
(D) connecting a first user-selected solid-state devices or appliances to a first panel controllable connection; and
(E) enabling power transmission to said first user-selected solid-state devices in response to said programming of said first user interface and controller to select said first user-selected solid-state device or appliance by generating a first Internet Protocol (“IP”) user instruction signal for transmission in response to selected user inputs identifying a desired energy use “on” states for said first solid-state devices or appliances.

11. The method of claim 10, further comprising:
(F) programming said first user interface and controller to indicate, for said user-selected solid-state device or appliance, whether said device or appliance is subject to emergency interruption.

12. The method of claim 11, further comprising:
(G) programming said first user interface and controller to indicate, for said user-selected solid-state device or appliance, whether said device or appliance is subject to manual interruption.

13. The method of claim 12, further comprising:
(H) programming said first user interface and controller to indicate, for said user-selected solid-state device or appliance, whether said device or appliance is subject to operation according to a user-defined schedule.

14. The method of claim 13, further comprising:
(I) programming said first user interface and controller to indicate, for said user-selected solid-state device or appliance, whether said device or appliance is belongs to one of four groups, namely,
(i) a device or appliance which is always on and not subject to emergency interruption;
(ii) a device or appliance which is always on and subject to emergency interruption;
(iii) a device or appliance which is enabled or run in response to said user-defined schedule and subject to manual interruption and emergency interruption; or
(iv) a device or appliance which is normally “off” and subject to emergency interruption and manual interruption.

15. The method of claim 14, further comprising:
(J) Transmitting a desired energy use “on-off” states for said selected solid-state device or appliance to said panel via an Ethernet connection.

16. The method of claim 14, further comprising:
(J) Transmitting said desired energy use “on-off” states for each of said selected solid-state devices or appliances to said panel via wireless data telemetry.

17. The method of claim 16, further comprising:
(K) Transmitting said desired energy use “on-off” states for said selected solid-state device or appliance to said panel via a Smart Phone device or wireless enabled Tablet device programmed with an Application including program instructions to transmit said desired energy use “on-off” states for each of said selected solid-state devices or appliances.
